(19) United States
(12) Patent Application Publication
(10) Pub. No.: US 2016/0238880 A1
(43) Pub. Date: Aug. 18, 2016

(54) LARGE POWER CIRCUIT AND MANUFACTURING METHOD THEREOF

(71) Applicant: SHENZHEN CHINA STAR OPTOELECTRONICS TECHNOLOGY CO., LTD., Shenzhen, Guangdong (CN)

(72) Inventors: Bingjei LIAO, Shenzhen, Guangdong (CN); Liang XU, Shenzhen, Guangdong (CN); Jiaxing MA, Shenzhen, Guangdong (CN); Chaomu CHEN, Shenzhen, Guangdong (CN)

(73) Assignee: Shenzhen China Star Optoelectronics Technology Co., Ltd., Shenzhen, Guangdong (CN)

(21) Appl. No.: 14/384,634

(22) PCT Filed: Jul. 18, 2014
(86) PCT No.: PCT/CN2014/082529

§ 371 Date: Sep. 11, 2014

(30) Foreign Application Priority Data
Apr. 14, 2014 (CN) 201410149194.1

(51) Int. Cl. G02F 1/1335; G02F 1/1339; G02F 1/1343

(52) U.S. Cl. CPC G02F 1/133514; G02F 1/13439; G02F 1/133512; G02F 1/13394; G02F 2001/133302

(57) ABSTRACT

The present invention provides a large power circuit and a manufacture method thereof. The large power circuit comprises a color filter substrate and an array substrate which are opposed, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electric currents. The present invention also provides a corresponding manufacture method of the large power circuit. The requirements for CVD apparatus can be reduced according to the large power circuit and the manufacture method thereof of the present invention. It is beneficial to achieve a better usage ratio of a glass substrate to obtain better benefits and eliminate the occurrence possibility of electrostatic damage.

### FIELD OF THE INVENTION

The present invention relates to a display skill field, and more particularly to a large power circuit design and a manufacture method thereof.

### BACKGROUND OF THE INVENTION

With the development of the world constructed by information, the requirements of display device have been growing. For satisfying such requirements, the recent panel display devices, such as a liquid crystal display (LCD), a plasma display panel (PDP) and an Organic Light-Emitting Diode (OLED) display have been developing so rapidly. In these panel display devices, the LCD has gradually replaced the cathode ray tube (CRT) display device with its advantages, light weight, small volume and low power consumption.

In the early stage, Twisted Nematic (TN) or Super Twisted Nematic (STN) LCD displays which have developed first possess issues of low contrast ratio and narrow view angle. With the advance in living standard, more and higher demands appear to the display devices. Consequently, the wide view angle technology, such as In Plan Switch (IPS), Vertical Alignment (VA) has fleetly developed.

The In Plan Switch display device has very good wide view angle display effect. However, for realizing the better display effect of the In Plan Switch, an extremely high standard is required for the rub procedure. Significantly, almost no tolerance can exist for the rub process. From time to time, related issues happen during a massive manufacture production.

Please refer to FIG. 1a and FIG. 1b. FIG. 1a is a diagram of a Vertical Alignment without power according to prior art (alignment layer is omitted) and FIG. 1b is a diagram of a Vertical Alignment with power according to prior art (alignment layer is omitted). For a Vertical Alignment, a LCD device mainly comprises an upper substrate 111, a lower substrate 112 and negative liquid crystal molecules 114 sandwiched between the two substrates. Both at the inner sides of the upper substrate 111 and the lower substrate 112, transparent conductive layers (ITO) 113 are provided to form a vertical electric field; the negative liquid crystal molecules 114 between the two transparent conductive layers 113 are liquid crystal that the permittivity of the liquid crystal long molecular axis is smaller than the permittivity in the direction perpendicular with the liquid crystal long molecular axis. As shown in FIG. 1a, under circumstance that the negative liquid crystal molecules 114 without the effect of the vertical electric field, the negative liquid crystal molecules 114 are aligned to be perpendicular with the surfaces of the substrates. As shown in FIG. 1b, the negative liquid crystal molecules 114 are aligned to a specific direction under the effect of the vertical electric field and ultimately to be aligned as perpendicular with the direction of the electric field because the permittivity of the liquid crystal long molecular axis is smaller. Compared with IPS, the Vertical Alignment does not require rub process and provides advantages as considering about the massive manufacture production.

Please refer to FIG. 2a and FIG. 2b. FIG. 2a is a diagram of a Multi-domain Vertical Alignment without power according to prior art (alignment layer is omitted) and FIG. 2b is a diagram of a Multi-domain Vertical Alignment with power according to prior art (alignment layer is omitted). As shown in FIG. 2a and FIG. 2b, an initial Vertical Alignment is a Multi-domain Vertical Alignment. For the Multi-domain Vertical Alignment, a LCD device mainly comprises an upper substrate 111, a lower substrate 112 and negative liquid crystal molecules 114 sandwiched between the two substrates. Both at the inner sides of the upper substrate 111 and the lower substrate 112, transparent conductive layers (ITO) 113 are provided to form a vertical electric field. As shown in FIG. 2a, under circumstance that the negative liquid crystal molecules 114 without the effect of the vertical electric field, the negative liquid crystal molecules 114 are aligned to be perpendicular with the surfaces of the substrates. As shown in FIG. 2b, the negative liquid crystal molecules 114 are aligned as perpendicular with the direction of the electric field. The distinguishing feature of this mode is to realize the multi-domain display (in general, four domains) by forming ribs 115 having certain appearances on the upper substrate 111 of the color film side. This arrangement improves the view angle issue of Vertical Alignment in advance. However, related issues remain: the negative liquid crystal molecules 114 in certain area around the ribs 115 cannot be aligned vertically so well. Even right in front of the panel, larger light leak may occur to affect the promotion of the contrast ratio property of the Multi-domain Vertical Alignment.

Possible improvements are proposed with the development of aforementioned technology, the Patterned Vertical Alignment (PVA). The property of the PVA is that the ribs at the color film side are not required but patterns, such as corresponding ITO slits and etc. are manufactured on the transparent electrode (ITO). The widths of the slits are generally in a range of about 8-15 μm for realizing the Multi-domain display. As shown in FIG. 3a and FIG. 3b. FIG. 3a is a diagram of a Patterned Vertical Alignment without power according to prior art (alignment layer is omitted), and FIG. 3b is a diagram of a Patterned Vertical Alignment with power according to prior art (alignment layer is omitted); For a Pattern Vertical Alignment, a LCD device mainly comprises an upper substrate 111, a lower substrate 112 and negative liquid crystal molecules 114 sandwiched between the two substrates. Both at the inner sides of the upper substrate 111 and the lower substrate 112, transparent conductive layers (ITO) 113 are provided to form a vertical electric field. As shown in FIG. 3a, under circumstance that the negative liquid crystal molecules 114 without the effect of the vertical electric field, the negative liquid crystal molecules 114 are aligned to be perpendicular with the surfaces of the substrates. As shown in FIG. 3b, the negative liquid crystal molecules 114 are aligned as perpendicular with the direction of the electric field. The property of the PVA is to form ITO slits 116 on the upper substrate 111 of the color film side. This method overcomes the necessary ribs at the color film side and enormously reduces the light leak.

Nevertheless, the foregoing two technologies still possess another problem. For either of MVA or PVA, the transmissivities at ribs and the ITO slits are much smaller than those of other normal pixel areas. Accordingly, the influence to the total transmissivity of the product does exist.

At this point, a new kind of Vertical Alignment is proposed. The property of the Vertical Alignment is that neither ribs nor ITO slits are required at the color film side. Not only the manufacture cost of the color film is saved but also the total transmissivity is improved. Such mode is so call Polymer Sustained Vertical Alignment (PSVA). The color film thereof is different from MVA and PVA. The used liquid crystal is also different. In the liquid crystal of PSVA, reactive monomers are added in the previous negative liquid crystal. After the liquid crystal cell is completed. The polymerization of the reactive monomers occurs under intensification of the ultraviolet light by applying voltage to two ends of the liquid crystal cell. Accordingly, the photo alignment of the liquid crystal is now accomplished. In this process, neither the light nor the electricity should be neglected.

As shown in FIG. 4, which is a diagram of a large glass substrate power circuit according to prior art. Generally, the liquid crystal cell 119 is applied with a voltage for the photo alignment. A series of power terminals, such as gate terminals 121, data terminals 122, array side common electrode terminals 123 and color film side common electrode terminals are set at the outer region of the large glass substrate. After the array substrate and the color filter substrate 124 are attached together, these terminals are covered under the color filter substrate 124. A first cut of cutting the edge of the color filter substrate 124 is required to reveal these terminals. The terminals are conducted into liquid crystal cell 119 via a series of wirings 120 in the inner region of the large substrate.

The power circuit and particular the power alignment circuit of the common PSVA is located at the edge of the large substrate and leads to the problems below:

1. The power circuit is located on the lower substrate (array substrate). The lower substrate itself is a substrate that the wirings are highly integrated. Many film layers are metal films. The longer the power circuit is, the more chance that the electrostatic damage happens; the conditions of wiring crossing cannot be avoided under circumstance of long wirings. At the cross sections of the wirings, the electrostatic breakdown can easily happen. Consequently, the right voltage cannot be applied to the liquid crystal cell for the liquid crystal cell. Such wasted products may exist and affect the yield of the products;

2. Each screen demands independent wirings on the large substrate and the power circuit occupies partial area of the glass substrate. Accordingly, these wirings occupy a certain area of the glass substrate. The usage ratio of the glass substrate will be restricted for the promotion. It goes against improvement of the glass substrate usage ratio and reduction of the manufacture cost. In a manufacture competition, it is put at a disadvantage;

3. The power terminals of the power circuit are generally located at the edge of the large lower substrate, which is close to the edge of film formation area of CVD. In the manufacture processes, these metal terminals are demanded to be packaged except in the desired opens for guaranteeing no damage to the terminals in the entire manufacture process. For preventing the acid alkali corrosions to the metal terminals and the electrochemical corrosion in the long-term placement. The CVD equipment is requested to provide the film formation area closer to the edges. However, the formation of the dielectric film depends on the film formation ability of the CVD equipment. An over requirement can cause the increase of the equipment cost.

### SUMMARY OF THE INVENTION

An objective of the present invention is to provide a large power circuit capable of transferring a portion of a power circuit of a lower substrate to an upper substrate.

Another objective of the present invention is to provide a manufacture method of a large power circuit to transfer a portion of a power circuit of a lower substrate to an upper substrate.

For realizing the aforesaid objective, the present invention provides a large power circuit, comprising a color filter substrate and an array substrate which are opposed, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electric currents.

The conductors are gold glue.

The floating ITO pattern is formed at a common electrode layer of the color filter substrate.

The color filter substrate comprises a glass substrate, a black matrix pattern, a color filter, a photo spacer and a common electrode layer.

The color filter substrate comprises a glass substrate, a black matrix pattern, a photo spacer and a common electrode layer.

The array substrate comprises a color filter.

The present invention further provides a large power circuit, comprising: a color filter substrate and an array substrate which are oppositely positioned, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electrical currents;

wherein the conductors are gold glue.

The floating ITO pattern is formed at a common electrode layer of the color filter substrate.

The color filter substrate comprises a glass substrate, a black matrix pattern, a color filter, a photo spacer and a common electrode layer.

The color filter substrate comprises a glass substrate, a black matrix pattern, a photo spacer and a common electrode layer.

The array substrate comprises a color filter.

The present invention further provides a manufacture method of a large power circuit, comprising:

step S10, positioning a floating ITO pattern in an outer region of a color filter substrate;

step S20, positioning contact holes in an outer region of an array substrate where is close to an inner region of the array substrate, and the contact holes are electrically connected to wirings in the inner region of the array substrate, and positions of the contact holes match with the floating ITO pattern;

step S30, opposing the color filter substrate and the array substrate, and locating the conductors between the contact holes and the floating ITO pattern for conducting electric currents.

Wherein, the step S10 comprises:

step S11, positioning a substrate for ITO sputtering on a carrier;

step S12, manufacturing a transparent electrode and the floating ITO pattern with a sputter apparatus.

The carrier comprises stoppers for obstructing the ITO sputtering to form the floating ITO pattern.

The stoppers are U-shaped.

The benefits of the present invention are: distances between the power circuit (metal pattern) and edges of the lower substrate become larger, and the requirements for CVD apparatus can be reduced; the occupied area of the power circuit on the lower substrate is reduced, and it is beneficial to achieve a better usage ratio of a glass substrate to obtain better benefits; an overlapping area of wirings of the lower substrate is reduced to eliminate the occurrence possibility of electrostatic damage.

### BRIEF DESCRIPTION OF THE DRAWINGS

The technical solution, as well as beneficial advantages, of the present invention will be apparent from the following detailed description of an embodiment of the present invention, with reference to the attached drawings.

In drawings,

FIG. 1a is a diagram of a Vertical Alignment without power according to prior art (alignment layer is omitted);

FIG. 1b is a diagram of a Vertical Alignment with power according to prior art (alignment layer is omitted);

FIG. 2a is a diagram of a Multi-domain Vertical Alignment without power according to prior art (alignment layer is omitted);

FIG. 2b is a diagram of a Multi-domain Vertical Alignment with power according to prior art (alignment layer is omitted);

FIG. 3a is a diagram of a Patterned Vertical Alignment without power according to prior art (alignment layer is omitted);

FIG. 3b is a diagram of a Patterned Vertical Alignment with power according to prior art (alignment layer is omitted);

FIG. 4 is a diagram of a large glass substrate power circuit according to prior art;

FIG. 5a is a sectional diagram of a color filter substrate according to a first embodiment of the present invention;

FIG. 5b is a top view diagram of the color filter substrate according to the first embodiment of the present invention;

FIG. 6 is a sectional diagram of an array substrate according to the first embodiment of the present invention;

FIG. 7 is a sectional diagram of a liquid crystal cell according to the first embodiment of the present invention;

FIG. 8 is a sectional diagram of the liquid crystal cell in FIG. 7 to be powered and aligned;

FIG. 9a is a sectional diagram of a color filter substrate according to a second embodiment of the present invention;

FIG. 9b is a top view diagram of the color filter substrate according to the second embodiment of the present invention;

FIG. 10 is a sectional diagram of an array substrate according to the second embodiment of the present invention;

FIG. 11 is a sectional diagram of a liquid crystal cell according to the second embodiment of the present invention;

FIG. 12 is a sectional diagram of the liquid crystal cell in FIG. 11 to be powered and aligned;

FIG. 13 is a structural diagram of a fixture employed in a manufacture method of a large power circuit according to the present invention;

FIG. 14 is a stereo structural diagram showing a stopper area of the fixture employed in the manufacture method of the large power circuit according to the present invention;

FIG. 15 is a flowchart of the manufacture method of the large power circuit according to the present invention.

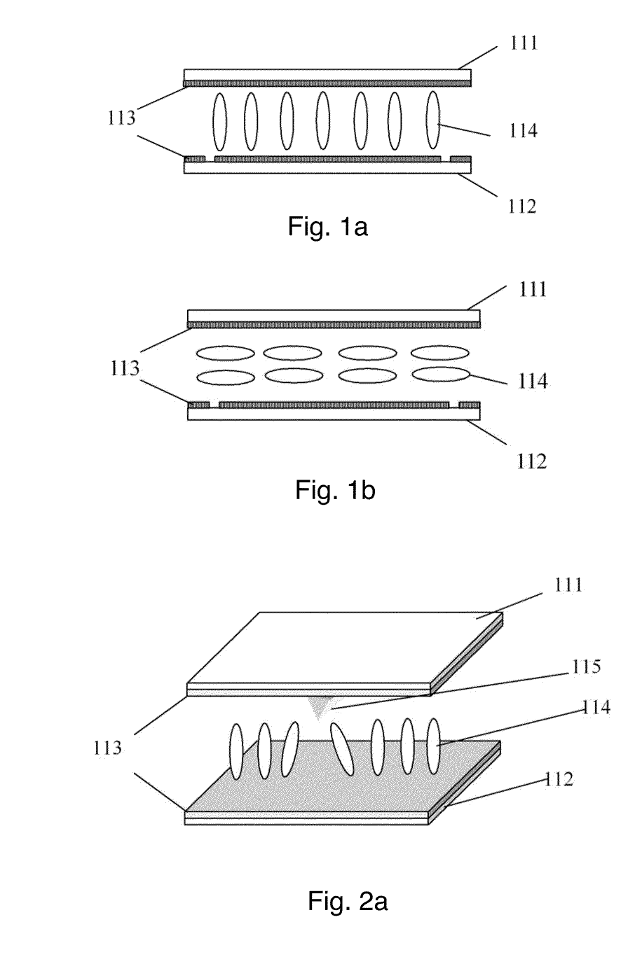

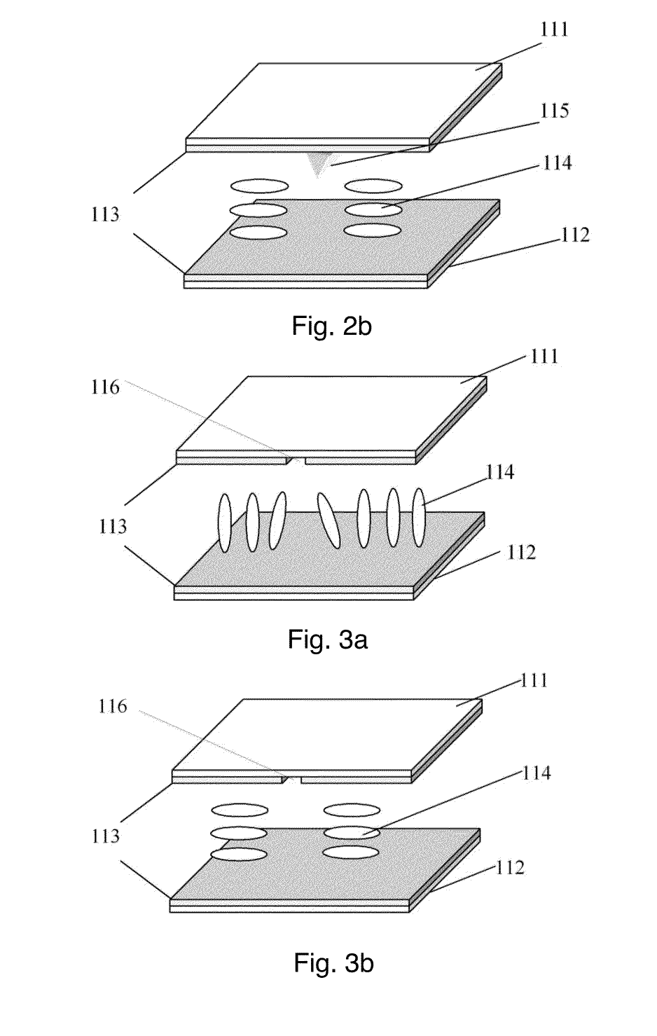

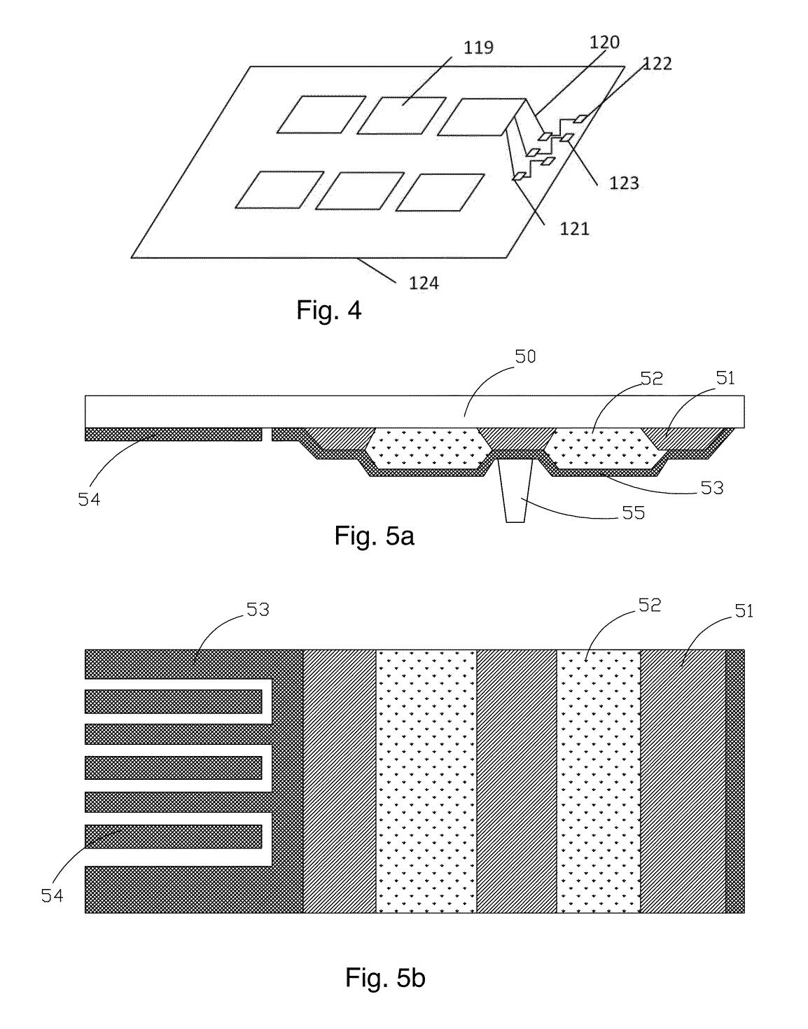

### DETAILED DESCRIPTION OF PREFERRED EMBODIMENTS

The large power circuit of the present invention comprises a color filter substrate and an array substrate which are opposed, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electric currents.

The present invention transfer the outer region portion of the power circuit on the array substrate (lower substrate) to the upper substrate: a shadow mask with a proper pattern is employed in the manufacture process of the common electrode on the upper substrate, a floating ITO pattern is formed, and the common electrode (ITO) of the upper substrate replaces power wirings previously are on an outer region of the lower substrate.

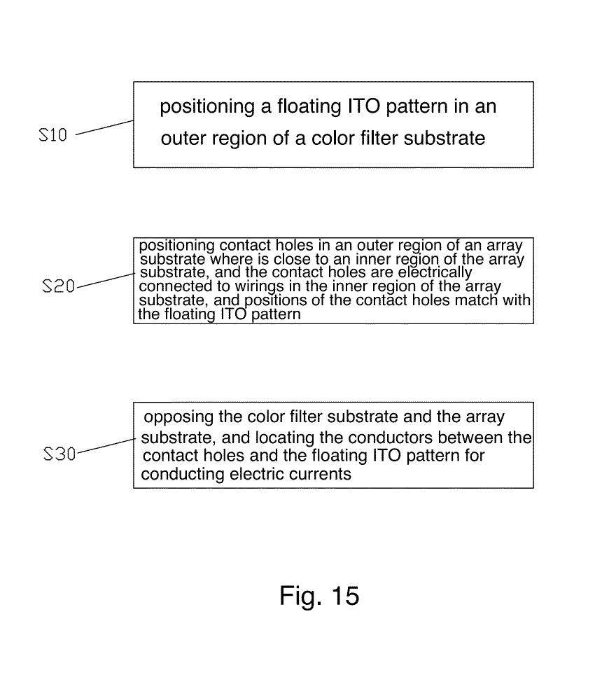

Please refer to FIG. 15, which is a flowchart of the manufacture method of the large power circuit according to the present invention.

The manufacture method of the large power circuit mainly comprises:

step S10, positioning a floating ITO pattern in an outer region of a color filter substrate;

step S20, positioning contact holes in an outer region of an array substrate where is close to an inner region of the array substrate, and the contact holes are electrically connected to wirings in the inner region of the array substrate, and positions of the contact holes match with the floating ITO pattern;

step S30, opposing the color filter substrate and the array substrate, and locating the conductors between the contact holes and the floating ITO pattern for conducting electric currents.

The step S10 further comprises:

step S11, positioning a substrate for ITO sputtering on a carrier;

step S12, manufacturing a transparent electrode and the floating ITO pattern with a sputter apparatus.

The carrier comprises stoppers for obstructing the ITO sputtering to form the floating ITO pattern.

Please refer to the following detailed description of the large power circuit and the manufacture method thereof according to the present invention is concerned with the diagrams. It is understandable to persons who are skilled in the art that the present invention is related to a large power circuit. Provide reference related to an array substrate, a color filter substrate and a manufacture method thereof of the accompanying drawings and description only and is not intended to be limiting of the invention but in conjunction with the large power circuit of the present invention.

As shown in FIG. 5a and FIG. 5b, and FIG. 5a is a sectional diagram of a color filter substrate according to a first embodiment of the present invention. FIG. 5b is a top view diagram of the color filter substrate according to the first embodiment of the present invention. In FIG. 5b, the glass substrate is omitted. The manufacture process of the upper substrate (color filter substrate) is described below:

manufacturing the black matrix pattern 51 after the glass substrate 50 is cleaned;

sequentially manufacturing a red blocking pattern, a green blocking pattern and a blue blocking pattern to form the color filter 52;

manufacturing a transparent electrode 53 (common electrode) with a sputter apparatus;

then, manufacturing photo spacer 55 with coater, exposure and development.

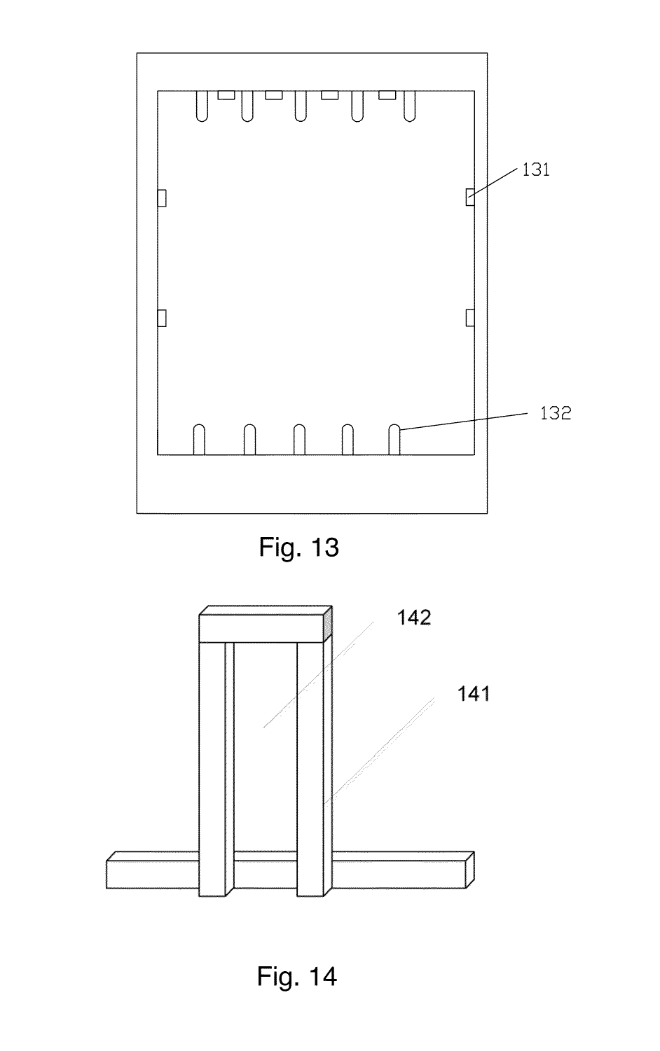

The manufacture of the transparent electrode 53 can be understood in conjunction with FIG. 13 and FIG. 14. As shown in FIG. 13, which is a structural diagram of a fixture employed in a manufacture method of a large power circuit according to the present invention, first, a substrate for ITO sputtering is positioned on a fixture of a carrier shown in FIG. 13. The clampers 131 are located around the fixture to fix the substrate. On the two sides of the fixture, U-shaped stoppers 132 are provided. Certainly, the stopper 132 is not restricted to be U-shaped. The number of the stoppers 132 can be adjusted on demands. Such fixture can be realized by adding the stoppers 132 at two sides of the present fixture.

As implementing the ITO sputtering, with the obstruction of the stoppers 132, no ITO is formed directly below the stoppers 132 and a floating ITO pattern 54 with a required number can be achieved. No red, green, blue nor black matrix layers appear under the floating ITO pattern 54.

As shown in FIG. 14, which is a stereo structural diagram showing a stopper area of the fixture employed in the manufacture method of the large power circuit according to the present invention, The stoppers comprises U-shaped stopping area 141. Inside the stopping area 141 is the desired film formation area.

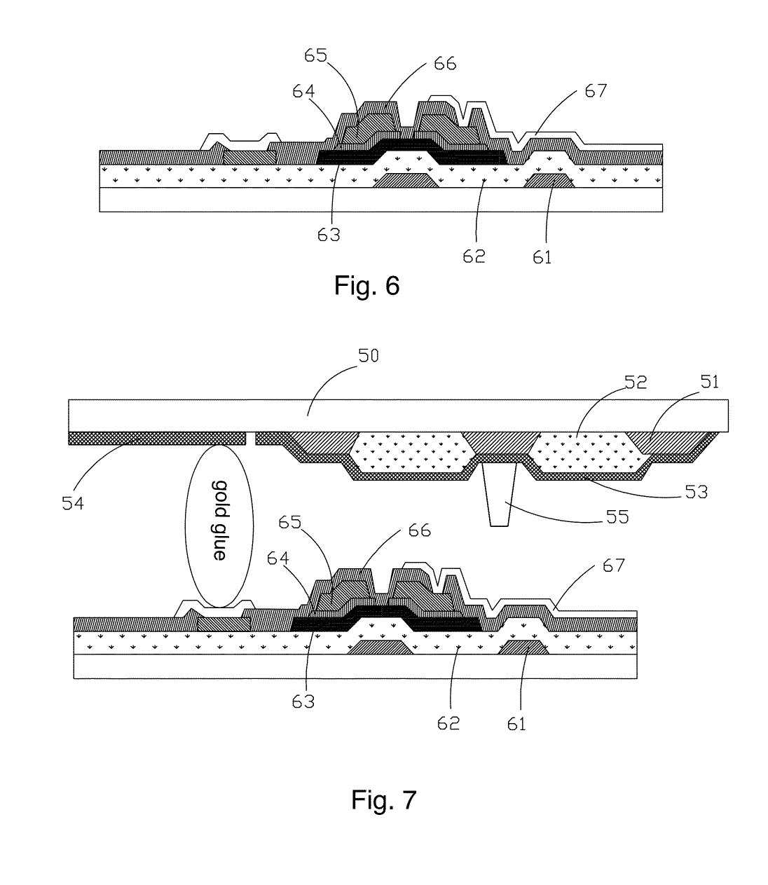

As shown in FIG. 6, which is a sectional diagram of an array substrate according to the first embodiment of the present invention, the manufacture process of the lower substrate (array substrate) is described below:

manufacturing a gate metal layer on the glass substrate 60 with a sputter apparatus;

obtaining a gate pattern 61 with exposure, development and etching;

manufacturing a dielectric film 62 and an amorphous silicon 63 with a CVD apparatus;

obtaining a silicon island 64 with exposure, development and etching;

manufacturing a source/a drain metal layer with a sputter apparatus;

obtaining a source/a drain pattern 65 with exposure, development and etching;

manufacturing a dielectric film 66 with a CVD apparatus;

removing dielectric film at the thin film transistor and other necessary locations with exposure, development and etching to reveal the metal below to manufacture contact holes;

manufacturing a pixel electrode/a common electrode 67.

The portion of the alignment power circuit previously in the outer region of the glass substrate is eliminated and replaced by the contact holes inside. The positions of these contact holes match with the floating ITO pattern 54 (transparent electrode) manufactured on the upper substrate.

As shown in FIG. 7, which is a sectional diagram of a liquid crystal cell according to the first embodiment of the present invention, after the upper substrate and the lower substrate are accomplished, a liquid crystal cell is completed with the cell process. After processes of substrate cleaning, alignment film coating, seal dispensing, one drop filling and etc., some gold glue (gold balls mixed into the seal) for conducting electric currents up and down can be manufactured with the seal dispensing process in the portion at the positions of the contact holes in the outer region.

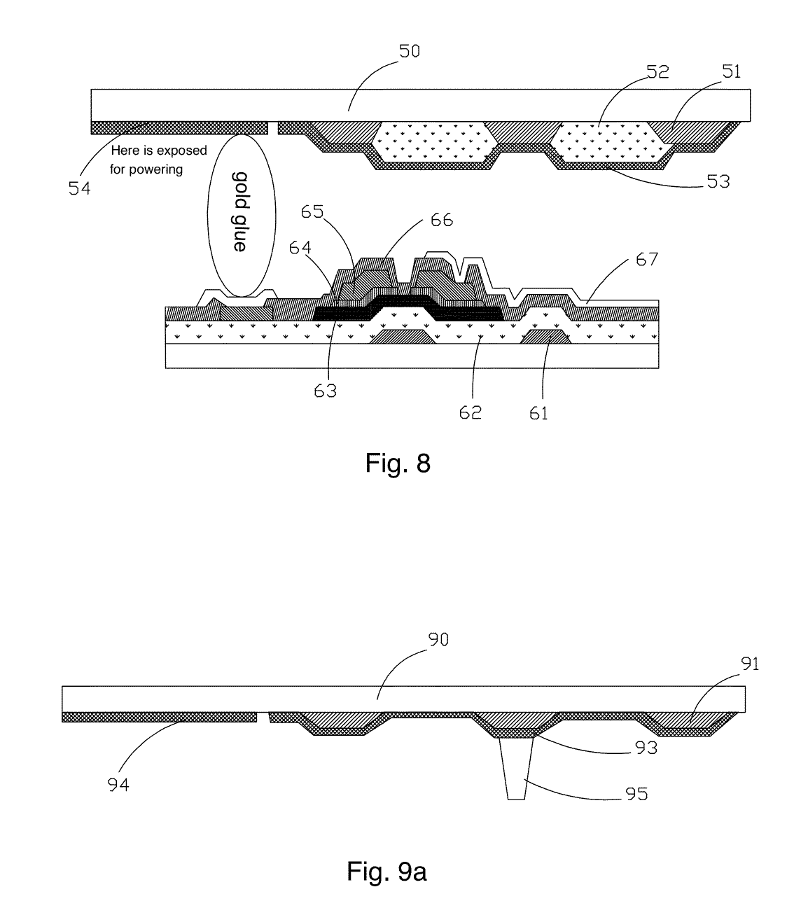

As shown in FIG. 8, which is a sectional diagram of the liquid crystal cell in FIG. 7 to be powered and aligned. After the manufacture of the liquid crystal cell is completed and before the photo alignment, the portion of the outer region of the lower substrate is cut by edge cutting. That is, the portion of the outer region without the contact holes is cut at the first cut; the large substrate still requires the second cut in the follow-up for completing the panel to reveal the power terminals of the upper substrate because the power terminals are covered by the upper substrate above and cannot be revealed. After cutting the outer region of the upper substrate, the power terminals can be exposed to realize the ultimate powering and alignment.

With the aforesaid method, the present invention realizes transferring the outer wirings of the lower substrate to the upper substrate and prevents kinds of issues due to the wirings located on the lower substrate.

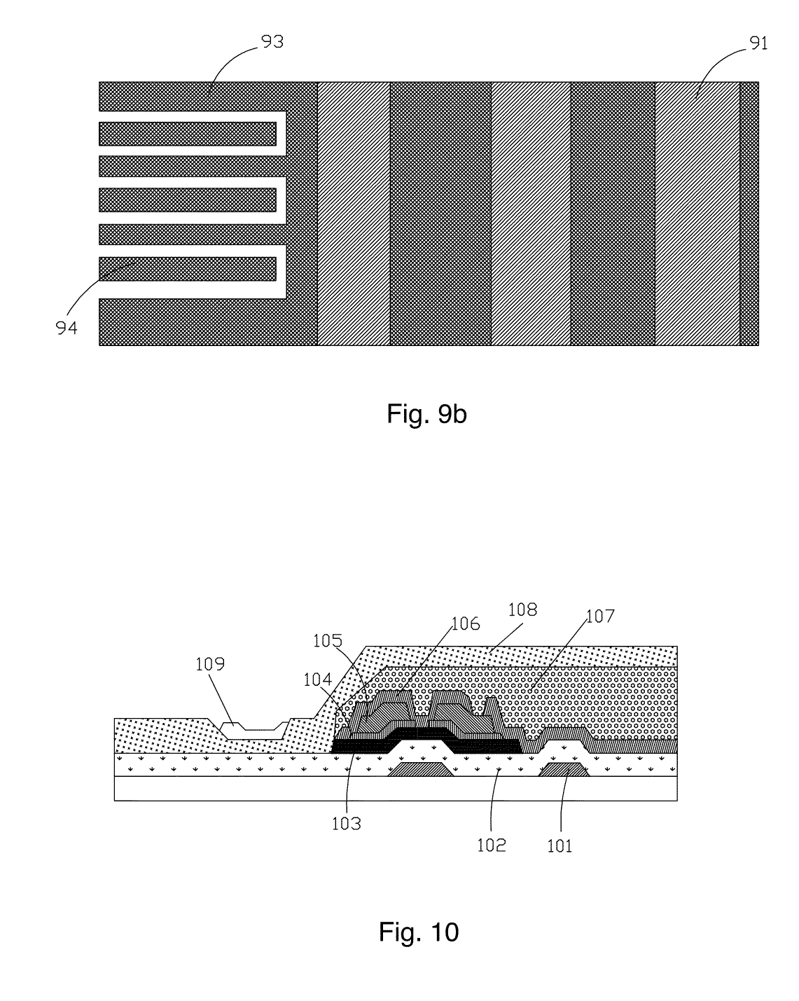

As shown in FIG. 9a and FIG. 9b, and FIG. 9a is a sectional diagram of a color filter substrate according to a second embodiment of the present invention. FIG. 9b is a top view diagram of the color filter substrate according to the second embodiment of the present invention. In FIG. 9b, the glass substrate is omitted. The manufacture process of the upper substrate (color filter substrate) is described below:

manufacturing the black matrix pattern 91 after the glass substrate 90 is cleaned;

manufacturing a transparent electrode 93 (common electrode) with a sputter apparatus,

as shown in FIG. 13, first, a substrate for ITO sputtering is positioned on a fixture of a carrier.

As implementing the ITO sputtering, with the obstruction of the stoppers 132, no ITO is formed directly below the stoppers 132 and a floating ITO pattern 94 with a required number can be achieved. No red, green, blue nor black matrix layers appear under the floating ITO pattern 94.

manufacturing photo spacer 55 with coater, exposure and development;

As shown in FIG. 10, which is a sectional diagram of an array substrate according to the second embodiment of the present invention, the manufacture process of the lower substrate (array substrate) is described below:

manufacturing a gate metal layer with a sputter apparatus;

obtaining a gate pattern 101 with exposure, development and etching;

manufacturing a dielectric film 102 and an amorphous silicon 103 with a CVD apparatus;

obtaining a silicon island 104 with exposure, development and etching;

manufacturing a source/a drain metal layer with a sputter apparatus;

obtaining a source/a drain pattern 105 with exposure, development and etching;

manufacturing a dielectric film 106 with a CVD apparatus;

sequentially manufacturing a red blocking pattern, a green blocking pattern and a blue blocking pattern to form the color filter 107;

manufacturing a dielectric film 108 with a CVD apparatus;

removing dielectric film at the thin film transistor and other necessary locations with exposure, development and etching to reveal the metal below;

manufacturing a common electrode 109;

wherein, the portion of the alignment power circuit previously in the outer region of the glass substrate is eliminated and replaced by the contact holes inside, i.e. the contact holes positioned in an outer region of the array substrate where is close to an inner region of the large substrate. The contact holes are connected to the wirings of the lower substrate, and then the wirings are conducted into the inner region of the large substrate. The positions of these contact holes match with the floating ITO pattern 94 (transparent electrode) manufactured on the upper substrate.

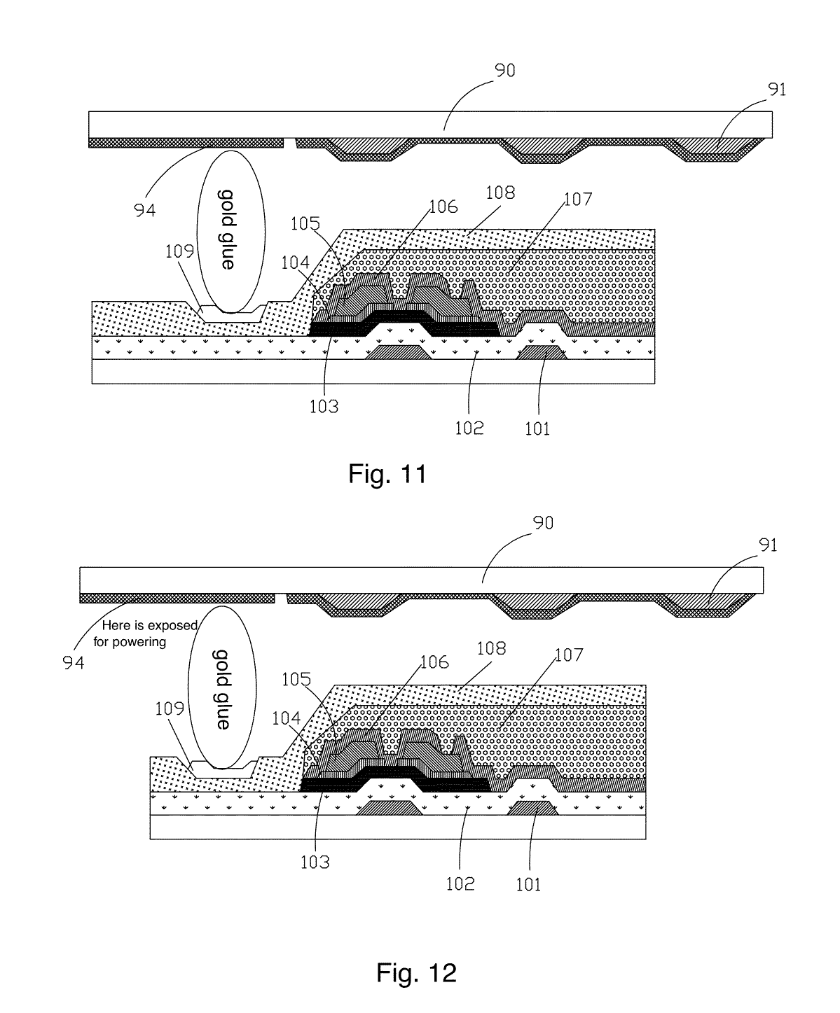

As shown in FIG. 11, which is a sectional diagram of a liquid crystal cell according to the second embodiment of the present invention, after the upper substrate and the lower substrate are accomplished, a liquid crystal cell is completed with the cell process. After processes of substrate cleaning, alignment film coating, seal dispensing, one drop filling and etc., some gold glue (gold balls mixed into the seal) for conducting electric currents up and down can be manufactured with the seal dispensing process in the portion at the positions of the contact holes in the outer region.

As shown in FIG. 12, which is a sectional diagram of the liquid crystal cell in FIG. 11 to be powered and aligned. After the manufacture of the liquid crystal cell is completed and before the photo alignment, the portion of the outer region of the lower substrate is cut by edge cutting. Once the power terminals of the upper substrate are exposed, the ultimate powering and alignment can be realized.

With the aforesaid method, the present invention realizes transferring the outer wirings of the lower substrate to the upper substrate and prevents kinds of issues due to the wirings located on the lower substrate.

The benefits of the present invention are: distances between the power circuit (metal pattern) and edges of the lower substrate become larger, and the requirements for CVD apparatus can be reduced; the occupied area of the power circuit on the lower substrate is reduced, and it is beneficial to achieve a better usage ratio of a glass substrate to obtain better benefits; an overlapping area of wirings of the lower substrate is reduced to eliminate the occurrence possibility of electrostatic damage.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A large power circuit, comprising a color filter substrate and an array substrate which are opposed, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electric currents.

2. The large power circuit according to claim 1, wherein the conductors are gold glue.

3. The large power circuit according to claim 1, wherein the floating ITO pattern is formed at a common electrode layer of the color filter substrate.

4. The large power circuit according to claim 1, wherein the color filter substrate comprises a glass substrate, a black matrix pattern, a color filter, a photo spacer and a common electrode layer.

5. The large power circuit according to claim 1, wherein the color filter substrate comprises a glass substrate, a black matrix pattern, a photo spacer and a common electrode layer.

6. The large power circuit according to claim 5, wherein the array substrate comprises a color filter.

7. A large power circuit, comprising a color filter substrate and an array substrate which are oppositely positioned, and a floating ITO pattern is positioned in an outer region of the color filter substrate, and contact holes are positioned in an outer region of the array substrate where is close to an inner region of the array substrate, and the contact holes are electrically connected to wirings in the inner region of the array substrate, and positions of the contact holes match with the floating ITO pattern, and conductors are located between the contact holes and the floating ITO pattern for conducting electrical currents;
wherein the conductors are gold glue.

8. The large power circuit according to claim 7, wherein the floating ITO pattern is formed at a common electrode layer of the color filter substrate.

9. The large power circuit according to claim 7, wherein the color filter substrate comprises a glass substrate, a black matrix pattern, a color filter, a photo spacer and a common electrode layer.

10. The large power circuit according to claim 7, wherein the color filter substrate comprises a glass substrate, a black matrix pattern, a photo spacer and a common electrode layer.

11. The large power circuit according to claim 10, wherein the array substrate comprises a color filter.

12. A manufacture method of a large power circuit, comprising:
step S10, positioning a floating ITO pattern in an outer region of a color filter substrate;
step S20, positioning contact holes in an outer region of an array substrate where is close to an inner region of the array substrate, and the contact holes are electrically connected to wirings in the inner region of the array substrate, and positions of the contact holes match with the floating ITO pattern;
step S30, opposing the color filter substrate and the array substrate, and locating the conductors between the contact holes and the floating ITO pattern for conducting electric currents.

13. The manufacture method of the large power circuit according to claim 12, wherein the step S10 comprises:
step S11, positioning a substrate for ITO sputtering on a carrier;
step S12, manufacturing a transparent electrode and the floating ITO pattern with a sputter apparatus.

14. The manufacture method of the large power circuit according to claim 13, wherein the carrier comprises stoppers for obstructing the ITO sputtering to form the floating ITO pattern.

15. The manufacture method of the large power circuit according to claim 14, wherein the stoppers are U-shaped.
